(19) United States
(12) Patent Application Publication
(10) Pub. No.: US 2015/0300956 A1
(43) Pub. Date: Oct. 22, 2015

(54) QUALITY MANAGEMENT METHOD FOR NEGATIVE ELECTRODE ACTIVE MATERIAL OF LITHIUM-ION SECONDARY BATTERY, METHOD OF MANUFACTURING NEGATIVE ELECTRODE OF LITHIUM-ION SECONDARY BATTERY, METHOD OF MANUFACTURING LITHIUM-ION SECONDARY BATTERY, NEGATIVE ELECTRODE OF LITHIUM-ION SECONDARY BATTERY, AND LITHIUM-ION SECONDARY BATTERY

(71) Applicants: Shinji FUJIEDA, Tokyo (JP); Takashi MIYAZAKI, Toyko (JP); Akio TODA, Tokyo (JP); Toshinari ICHIHASHI, Tokyo (JP)

(72) Inventors: Shinji FUJIEDA, Tokyo (JP); Takashi MIYAZAKI, Toyko (JP); Akio TODA, Tokyo (JP); Toshinari ICHIHASHI, Tokyo (JP)

(73) Assignee: NEC CORPORATION, Tokyo (JP)

(21) Appl. No.: 14/648,220

(22) PCT Filed: Jun. 7, 2013
(86) PCT No.: PCT/JP2013/065836

§ 371 Date: May 28, 2015

(30) Foreign Application Priority Data
Nov. 29, 2012 (JP) 2012-260850

(51) Int. Cl. G01N 21/65; H01M 4/583; H01M 10/0525; G01N 21/01

(52) U.S. Cl. CPC G01N 21/65; G01N 21/01; H01M 4/583; H01M 10/0525

(57) ABSTRACT

An object is to provide means, which is capable of performing quality management with sufficient precision even in a case where the thickness of an amorphous carbon layer is small, as quality management means for a negative electrode active material of a lithium-ion secondary battery including an amorphous carbon layer on a surface. Provided is a quality management method for a negative electrode active material of a lithium-ion secondary battery which includes an amorphous carbon layer on a surface. In the quality management method, an aspect of a change in a plurality of D/G ratios, which are obtained by performing a first process of heating an inspection object at a predetermined heating temperature, and of measuring each of the D/G ratios through Raman scattering spectroscopy measurement a predetermined number of times while changing the heating temperature, is set as an index of the quality management.

### TECHNICAL FIELD

The present invention relates to a quality management method for a negative electrode active material of a lithium-ion secondary battery, a method of manufacturing a negative electrode of a lithium-ion secondary battery, a method of manufacturing a lithium-ion secondary battery, a negative electrode of a lithium-ion secondary battery, and a lithium-ion secondary battery.

### BACKGROUND ART

A lithium-ion secondary battery (LIB) has been put into a practical use in a portable information terminal or an electric vehicle. A reduction in cost is necessary for additional spreading of the LIB which includes electricity storage on a large scale. Carbon is typically used as a negative electrode active material of the LIB, but it is desirable to use natural graphite from the viewpoint of cost. The natural graphite is inexpensive and a capacity density thereof is high. However, crystallinity thereof is high, and thus an electrolytic solution such as ethylene carbonate tends to be decomposed in a LIB cell. It is effective for a surface of secondary particles of graphite nucleus material to be coated with amorphous carbon that is formed by firing pitch, through chemical vapor deposition (CVD), and the like so as to suppress decomposition of the electrolytic solution (PTL 1, PTL 2, and PTL 3).

Raman scattering spectroscopy measurement is effective for quality management of an amorphous carbon coated layer of a carbon-based active material. For example, Patent Document 1 discloses quality management of a carbon material in a carbon negative electrode for a nonaqueous secondary battery in which the carbon material obtained by forming an amorphous carbon layer on a surface of the carbon material as a nucleus is set as an active material, specifically, “a ratio (D/G ratio) of peak intensity of 1360 cm⁻¹ to peak intensity of 1580 cm⁻¹ in an argon laser Raman spectrum is set to be equal to or less than 0.4”.

In addition, thermal gravimetric-differential thermal analysis (TG-DTA) is also used for quality management of an amorphous layer that exists on the surface of the carbon-based active material. For example, Patent Document 4 discloses quality management for artificial graphite secondary particles, which have a surface layer in a low-crystallinity or amorphous state, on an outermost surface, specifically, “in thermal gravimetric-differential thermal analysis performed in an air circulation atmosphere, a reduction in weight and heat generation are allowed to occur at a temperature of equal to or higher than 640° C., and the reduction in weight after heating for 30 minutes at 650° C. is set to be less than 3%”.

### RELATED DOCUMENT

### Patent Document

[Patent Document 1] Japanese Patent No. 2643035

[Patent Document 2] Japanese Patent No. 3304267

[Patent Document 3] Japanese Patent No. 3481063

[Patent Document 4] Japanese Patent No. 4448279

### Non-Patent Document

[Non-Patent Document 1] Journal of Non-Crystalline Solids 227-230 (1998), I. Pocsik et al., pages 1083 to 1086, FIG. 1 and FIG. 2.

### DISCLOSURE OF THE INVENTION

The amorphous carbon coated layer has an effect of suppressing decomposition of the electrolytic solution of the LIB, but in a case of a large thickness, a decrease in a capacity is caused to occur at an initial stage of charging and discharging. It is desirable for the amorphous carbon coated layer to be thin so as to reduce an initial irreversible capacity.

In a case of the carbon-based active material in which the amorphous carbon coated layer formed on a surface of graphite is relatively homogeneous and a coated layer is thick (approximately, equal to or greater than 10 nm as a standard), it is considered that the quality management method, which is disclosed in Patent Document 1 or Patent Document 4, is effective. However, in a case of an ultra-thin coated layer of less than 10 nm, although depending on a manufacturing process, coating may be non-homogeneous, and thus the thickness may not be uniform.

With regard to an argon laser that is frequently used as excitation light in Raman scattering spectroscopy, in light having a wavelength of 488 nm, a penetration length into carbon is several tens of nanometers. In a case where the penetration length and an escape depth of Raman scattering light are approximately equal to or greater than the thickness of the coated layer, a signal of the Raman scattering includes contribution not only from the amorphous carbon coated layer but also from the graphite nucleus material. The D/G ratio in the Raman scattering is not determined by only an average film quality and an average film thickness of the coated layer, but also depends on inhomogeneity and non-uniformity in the thickness. Due to the above-described reasons, in a case of a technology described in Patent Document 1, there is a concern that when the amorphous carbon coated layer is thin, the quality management may not be performed sufficiently.

In addition, in a case where the amorphous carbon coated layer is not homogeneous, and the film thickness thereof is also not uniform, a distribution in a combustion temperature of the coated layer becomes broad. According to this, a clear peak may not be detected in the TG-DTA measurement in which a weight loss or heat generation due to combustion of carbon is monitored during temperature scanning, and thus it is difficult to determine the amount of the amorphous carbon or the elaborateness (a level of the combustion temperature) thereof. For this reason, in a case of a technology described in Patent Document 4, there is a concern that when the amorphous carbon coated layer becomes thin, the quality management may not be performed sufficiently.

An object of the invention is to provide means, which is capable of performing quality management with sufficient precision even in a case where the thickness of an amorphous carbon layer is small, as quality management means for a negative electrode active material of a lithium-ion secondary battery including an amorphous carbon layer on a surface.

According to an aspect of the invention, there is provided a quality management method for a negative electrode active material of a lithium-ion secondary battery which includes an amorphous carbon layer on a surface. An aspect of a change in a plurality of D/G ratios, which are obtained by performing a first process of heating an inspection object at a predetermined heating temperature, and of measuring each of the D/G ratios through Raman scattering spectroscopy measurement a predetermined number of times while changing the heating temperature, is set as an index of the quality management.

In addition, according to another aspect of the invention, there is provided a method of manufacturing a negative electrode of a lithium-ion secondary battery. The method includes a process of inspecting an inspection object by using the quality management method for a negative electrode active material of a lithium-ion secondary battery.

In addition, according to still another aspect of the invention, there is provided a method of manufacturing a lithium-ion secondary battery. The method includes a process of inspecting an inspection object by using the quality management method for a negative electrode active material of a lithium-ion secondary battery.

In addition, according to still another aspect of the invention, there is provided a negative electrode active material of a lithium-ion secondary battery. The negative electrode active material includes an amorphous carbon layer on a surface. A first D/G ratio (peak area ratio) before heating, which is obtained by Raman scattering spectroscopy measurement at an excitation wavelength of 488 nm at room temperature, is equal to or greater than 0.5. The heating is performed while raising a temperature in a mixed gas atmosphere including 80% nitrogen and 20% oxygen under conditions in which a gas flow rate is set to 2.5 cm/s, a heating temperature rising rate is set to 3 K/min, and an amount of a sample is set to 20 mg, and when the heating temperature reaches 480° C., a second D/G ratio, which is obtained by the Raman scattering spectroscopy measurement at an excitation wavelength of 488 nm at room temperature, is changed from the first D/G ratio in a rate of change of less than 10%. When the heating temperature reaches 630° C., a third D/G ratio, which is obtained by the Raman scattering spectroscopy measurement at an excitation wavelength of 488 nm at room temperature, is equal to or less than 0.25.

In addition, according to still another aspect of the invention, there is provided a negative electrode that is manufactured by using the negative electrode active material.

In addition, according to still another aspect of the invention, there is provided a lithium-ion secondary battery that is manufactured by using the negative electrode.

According to the invention, even in a case where the thickness of an amorphous carbon layer that is positioned on a surface of a negative electrode active material of a lithium-ion secondary battery is small, it is possible to perform quality management of a negative electrode with sufficient precision.

### BRIEF DESCRIPTION OF THE DRAWINGS

The above and other objects, advantages and features of the present invention will be more apparent from the following description of certain preferred embodiments taken in conjunction with the accompanying drawings.

FIG. 1 is a view illustrating TG-DTA data (a temperature derivative of a weight loss) of active materials A, B, C, and D.

FIG. 2 is a plot of a Raman scattering D/G ratio of the active materials A, B, C, and D with respect to a combustion temperature.

FIG. 3 is a plot of the Raman scattering D/G ratio of the active materials A, B, C, and D with respect to a weight temperature.

### DESCRIPTION OF EMBODIMENTS

Hereinafter, embodiments of the invention will be described with reference to the accompanying drawings. However, in all drawings, the same reference numeral will be given to the same constituent element, and description thereof will not be repeated.

### First Embodiment

First, a quality management method for a negative electrode active material of a lithium-ion secondary battery of this embodiment will be described. In this embodiment, a quality management method for a negative electrode active material of a lithium-ion secondary battery which includes an amorphous carbon layer on a surface is provided. This negative electrode can be manufactured in accordance with the related art, and thus detailed description thereof will not be repeated. In addition, the film thickness of the amorphous carbon layer may be less than 10 nm.

In the quality management method for the negative electrode active material of the lithium-ion secondary battery according to this embodiment, an aspect of a change in a plurality of D/G ratios, which are obtained by performing a first process of heating an inspection object (at least a part of the negative electrode) at a predetermined heating temperature, and of measuring each of the D/G ratios (peak area ratios or peak height ratios) through Raman scattering spectroscopy measurement a predetermined number of times while changing the heating temperature, is set as an index of the quality management.

A part of the amorphous carbon layer or the entirety thereof is combusted by the heating at a predetermined temperature. According to this, the D/G ratio is changed by the heating. As illustrated in the following examples, as the heating temperature is raised, the D/G ratio decreases, and gradually converges to a predetermined value. Here, a D/G ratio before heating is set as a D/G ratio before heating, and a D/G ratio after convergence is set as a D/G ratio after convergence.

In addition, as illustrated in the following examples, in a case where the amorphous carbon layer on the a surface of the negative electrode, that is, the amorphous carbon layer that is formed on the surface of the graphite nucleus material is homogeneous, and the film thickness thereof is uniform, the D/G ratio is maintained at a value in the vicinity of the D/G ratio before heating up to a first heating temperature, but greatly decreases between the first heating temperature and a second heating temperature higher than the first heating temperature, and the D/G ratio immediately after heating at the second heating temperature becomes a value in the vicinity of the D/G ratio after convergence.

On the other hand, as illustrated in the following examples, in a case where the amorphous carbon layer on the surface of the negative electrode is not homogeneous, and/or the film thickness is not uniform, the D/G ratio is maintained at a value in the vicinity of the D/G ratio before heating up to the first heating temperature, but more gradually decreases between the first heating temperature and the second heating temperature in comparison to the case in which the amorphous carbon layer is homogeneous and the film thickness is uniform. In addition, the D/G ratio immediately after heating at the second heating temperature becomes a value departing from the D/G ratio after convergence. In addition, the D/G ratio immediately after heating at a third heating temperature higher than the second heating temperature becomes a value in the vicinity of the D/G ratio after convergence. That is, the D/G ratio immediately after heating at the second heating temperature is small in a case where the amorphous carbon layer is homogeneous and the film thickness is uniform.

As described above, if a state (homogeneity, uniformity in the film thickness) of the amorphous carbon layer is different, an aspect of a change in the plurality of D/G ratios which are obtained by performing the first process a predetermined number of times while changing the heating temperature is different in each case. In this embodiment, the aspect of a change is set as an index of quality management of the amorphous carbon layer, that is, an index of quality management of the negative electrode of the lithium-ion secondary battery.

For example, in a case of a carbon-based active material including an amorphous carbon coated layer, which is homogeneous and uniform in the film thickness, on a surface of a graphite nucleus material, a decrease in the D/G ratio of Raman scattering occurs in a narrow heating temperature (combustion temperature) range. In contrast, in a case where the amorphous carbon coated layer is not homogeneous, and/or the film thickness is not uniform, the decrease in the D/G ratio in accordance with an increase in the heating temperature (combustion temperature) becomes gradual. It is possible to determine the homogeneity and uniformity of the amorphous carbon coated layer with reference to rapidity and slowness of the change in the D/G ratio in accordance with combustion of a surface.

In a case where combustion gradually occurs, a weight loss or heat generation does not show a clear peak with respect to the heating temperature (combustion temperature), and thus it is difficult to detect the amorphous carbon coated layer with the TG-DTA, but the D/G ratio of Raman scattering can be obtained for each combustion temperature. Accordingly, when observing an aspect of the change with respect to the combustion temperature, it is possible to detect generation of gradual combustion. In addition, when assuming the weight loss at each heating temperature with the TG-DTA and plotting the D/G ratio in combination with the weight loss, it is possible to determine an amount of the amorphous carbon coated film.

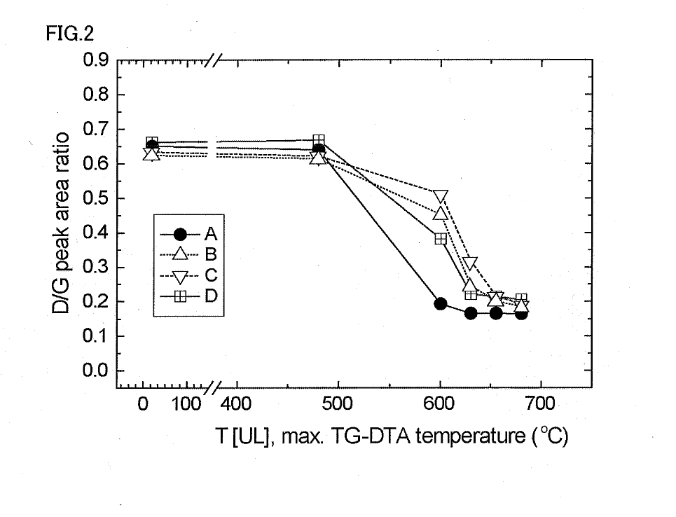

In this embodiment, for example, the aspect of a change in the D/G ratio with respect to a change in the heating temperature may be set as an index of quality management. As an example thereof, a rate of change of the D/G ratio when the heating temperature is changed from the first temperature to the second temperature can be set as the index of the quality management. When appropriately setting the first temperature and the second temperature, in a case where the amorphous carbon layer on the surface of the negative electrode, that is, the amorphous carbon layer formed on the surface of the graphite nucleus material is homogeneous, and the film thickness thereof is uniform, the rate of change (reduction rate) in the D/G ratio becomes larger than a predetermined value. In a case where the amorphous carbon layer on the surface of the negative electrode is not homogeneous and/or the film thickness is not uniform, the rate of change (reduction rate) in the D/G ratio becomes smaller than a predetermined value. It is possible to perform the quality management for the amorphous carbon layer by using the above-described tendency. For example, as illustrated in the following examples (particularly, FIG. 2), when the first temperature is set to any temperature that is equal to or lower than 480° C., and preferably equal to or higher than 400° C. and equal to or lower than 480° C., and the second temperature is set to any temperature of equal to or higher than 500° C. and equal to or lower than 650° C., preferably equal to or higher than 550° C. and equal to or lower than 625° C., and more preferably equal to or higher than 575° C. and equal to or lower than 625° C., the quality management can be sufficiently performed.

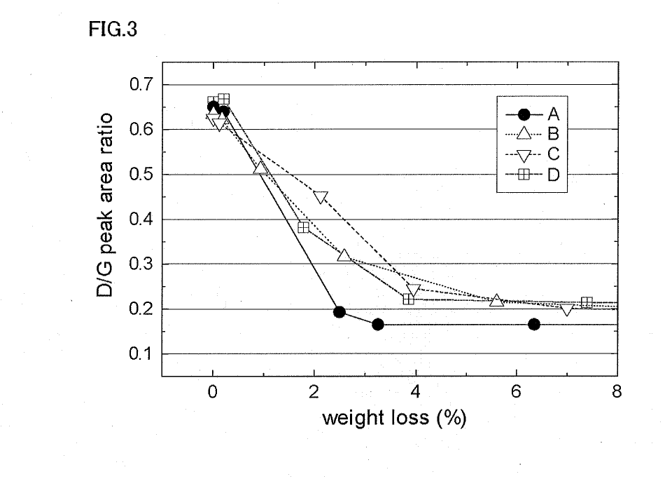

As another example, in the first process, a reduction in weight of an inspection object which is caused by the heating is further measured, and an aspect of a change in the D/G ratio with respect to the reduction in weight of the inspection object can be set as the index of the quality management. As an example thereof, the rate of change in the D/G ratio when the reduction in weight is changed from a first state to a second state can be set as the index of the quality management. When the first state (amount of reduction in weight) and the second state (amount of reduction in weight) are appropriately set, in a case where the amorphous carbon layer on the surface of the negative electrode, that is, the amorphous carbon layer formed on the surface of the graphite nucleus material is homogeneous, and the film thickness is uniform, the rate of change (reduction rate) in the D/G ratio becomes larger than a predetermined value. In a case where the amorphous carbon layer on the surface of the negative electrode is not homogeneous and/or the film thickness is not uniform, the rate of change (reduction rate) in the D/G ratio becomes smaller than a predetermined value. It is possible to perform the quality management for the amorphous carbon layer by using the above-described tendency. For example, as illustrated in the following examples (particularly, FIG. 3), when the first state is set to an amount of reduction in weight of 0%, and the second state is set to any amount of reduction in weight of 1% to 4%, preferably 2% to 4%, and more preferably 2% to 3%, the quality management can be sufficiently performed.

In addition, in the first process, the inspection object may be heated in an oxygen-containing atmosphere while raising a temperature thereof, and after the heating temperature reaches a predetermined temperature, the inspection object may be subjected to Raman scattering spectroscopy measurement using visible laser light.

According to this embodiment, it is possible to perform quality management for a state of the amorphous carbon coated layer that is formed on secondary particles of the graphite nucleus material.

A method of manufacturing the negative electrode of the lithium-ion secondary battery and a method of manufacturing the lithium-ion secondary battery according to this embodiment include a process of performing quality management for the negative electrode active material of the lithium-ion secondary battery, which is manufactured, by using the above-described quality management method of the negative electrode of the lithium-ion secondary battery. That is, state inspection for the amorphous carbon layer on the surface of the negative electrode active material, which is manufactured, is performed by using the above-described index, and the negative electrode active material in which homogeneity of the amorphous carbon layer, and uniformity of the film thickness satisfy a predetermined reference is picked up, and the negative electrode of the lithium-ion secondary battery and the lithium-ion secondary battery are manufactured by using the negative electrode active material that is picked up.

In addition, the film thickness of the amorphous carbon layer may be less than 10 nm. In the above-described quality management method for the negative electrode of the lithium-ion secondary battery, quality management can also be performed for the amorphous carbon layer with sufficient precision.

The negative electrode of the lithium-ion secondary battery, and the lithium-ion secondary battery, which are manufactured as described above, have high quality in which a deviation in quality is small.

### Second Embodiment

A quality management method for the negative electrode of the lithium-ion secondary battery of this embodiment is an embodiment that implements the quality management method of the negative electrode of the lithium-ion secondary battery of the first embodiment.

In the quality management method of this embodiment, after a carbon-based active material (inspection object), which is obtained by coating graphite nucleus material secondary particles with amorphous carbon, is subjected to TG-DTA measurement (heating in an oxygen-containing atmosphere during temperature-raising up to an arbitrary temperature T [UL]), the atmosphere is immediately changed to an inert gas, and temperature-lowering is performed to room temperature. Then, although an amount is different depending on the temperature T [UL], an active material, which remains without being combusted, is collected from a furnace of TG-DTA, and a Raman scattering spectrum is measured in a predetermined range (for example, a range of approximately 1000 cm⁻¹ to 1900 cm⁻¹).

Laser light is used in the Raman scattering measurement, but it is desirable to use visible light which does not excite a σ-bond between carbon atoms as a laser light source in order to make the Raman scattering spectrum to be a simple type. In this case, in the Raman scattering spectrum, a peak or a flat structure is observed in the vicinity of 1360 cm⁻¹ (D peak), in the vicinity of 1580 cm⁻¹ (G peak), in the vicinity of 1610 cm⁻¹ (D′ peak), and in the vicinity of 1470 cm⁻¹. However, attention is necessary to be paid to the fact that the position and intensity of the D peak are changed depending on a wavelength of excitation light (Non-Patent Document 1). The D peak and the D′ peak are signals which are exhibited from graphite including structural disturbance, and thus the D/G ratio becomes an index of an amorphous nature of an observation region. Fitting of the Raman scattering spectrum is performed to obtain the D/G ratio, but with regard to ultra-thin amorphous carbon coating, it is necessary to consider only the G peak, the D peak, and the D′ peak, and a function that describes the peak may be composed of a Lorentz-type for all of the three peaks. The Raman scattering measurement is performed with respect to a plurality of active material particles to obtain an average of D/G ratios.

The TG-DTA and the Raman scattering measurement (first process) are performed with respect to a plurality of upper-limit temperatures T [UL] (combustion temperatures, heating temperatures), and data is plotted by taking T [UL] on the horizontal axis, and the D/G ratio (a peak area ratio or a peak height ratio) on the vertical axis. In addition, instead of or in addition to the plotting, the plotting may be performed by taking a weight loss measured by TG-DTA up to T [UL] on the horizontal axis and the D/G ratio on the vertical axis. The plotting of the D/G ratio versus the combustion temperature, and/or the plotting of the D/G ratio versus the weight loss are set as a management index of the active material.

As illustrated in the following example in FIG. 2, in a case where the active material obtained by coating the graphite nucleus material with the amorphous carbon is combusted, the D/G ratio is maintained at a value that is approximately the same as that before combustion (initial D/G ratio) in a low-temperature region, the D/G ratio decreases in accordance with combustion of the amorphous carbon coated layer in an intermediate-temperature region, and the graphite nucleus material is exposed in a high-temperature region, and thus the D/G ratio is saturated to an approximately constant low value (a nucleus material D/G ratio). After acquiring data of the D/G ratio versus the combustion temperature and data of the D/G ratio versus the weight loss which become standards, D/G ratios and weight losses with respect to three points including (1) before combustion, (2) in the vicinity of the upper limit of the low-temperature region in which the initial D/G ratio is maintained, and (3) in the vicinity of the lower limit of the high-temperature region in which the D/G ratio is saturated to the nucleus material D/G ratio may be used as a management index without obtaining D/G ratios with respect to a number of combustion temperatures. Even in this manner, the quality management can be sufficiently performed. In addition, according to this manner, it is possible to suppress the number of times of measurement of the D/G ratio with respect to one measurement object from increasing in a useless manner, and thus a process can be simplified. Accordingly, this manner is preferable.

A method of manufacturing a negative electrode of a lithium-ion secondary battery, a method of manufacturing a lithium-ion secondary battery, a negative electrode of a lithium-ion secondary battery, and a lithium-ion secondary battery according to this embodiment are the same as those in the first embodiment.

According to this embodiment, it is possible to realize the same operational effect as in the first embodiment.

### Third Embodiment

A quality management method for the negative electrode active material of the lithium-ion secondary battery of this embodiment basically employs the configuration of the first and second embodiments, and is different from the first and second embodiments in details of a process of repetitively performing the first process while changing the heating temperature. The other processes may be executed in the same manner as the first and second embodiments.

In this embodiment, a TG-DTA apparatus is provided with a window through which visible light can be transmitted, an apparatus system having a Raman scattering measurement function is prepared, and TG-DTA measurement and Raman scattering measurement are performed through temperature scanning that is performed once. That is, a plurality of times of Raman scattering measurement is performed during a heating process that is performed once for temperature-raising up to a predetermined temperature. Specifically, the Raman scattering measurement is performed whenever reaching each predetermined temperature during a temperature-raising step. In this case, a Raman scattering spectrometer, which is capable of acquiring spectra of a plurality of active material regions in conformity to the temperature scanning of TG-DTA, is used.

Temperature dependency of Raman scattering signal intensity is different for each peak. However, when assuming that the signal intensity conforms to Bose-Einstein statistics, for example, an increment in the D/G ratio at 680° C. with respect to room temperature (25° C.) is as small as 4%, and thus an effect of a temperature is negligible at a combustion temperature of approximately 680° C.

A method of manufacturing a negative electrode of a lithium-ion secondary battery, a method of manufacturing a lithium-ion secondary battery, a negative electrode of a lithium-ion secondary battery, and a lithium-ion secondary battery of this embodiment are the same as those in the first embodiment.

According to this embodiment, it is possible to realize the same operational effect as in the first embodiment.

### Fourth Embodiment

A quality management method for the negative electrode active material of the lithium-ion secondary battery of this embodiment basically employs the configuration of the first to third embodiments, and further clarifies the index.

In the quality management method for the negative electrode active material of the lithium-ion secondary battery of this embodiment, an amorphous carbon layer satisfying the following (1) to (3) is regarded as an accepted product.

(1) A first D/G ratio (peak area ratio) before heating, which is obtained by Raman scattering spectroscopy measurement at an excitation wavelength of 488 nm at room temperature, is equal to or greater than 0.5.

(2) When heating is performed while raising a temperature in a mixed gas atmosphere including 80% nitrogen and 20% oxygen under conditions in which a gas flow rate is set to 2.5 cm/s, a heating temperature rising rate is set to 3 K/min, and an amount of a sample is set to 20 mg, and the heating temperature reaches 480° C., a second D/G ratio, which is obtained by the Raman scattering spectroscopy measurement at an excitation wavelength of 488 nm at room temperature, is changed from the first D/G ratio in a rate of change of less than 10%. The rate of change is defined by the following Equation.

(Rate of change)=(first D/G ratio−second D/G ratio)/first D/G ratio×100.

(3) When the heating temperature reaches 630° C., a third D/G ratio, which is obtained by the Raman scattering spectroscopy measurement at an excitation wavelength of 488 nm at room temperature, is equal to or less than 0.25.

A method of manufacturing a negative electrode of a lithium-ion secondary battery, a method of manufacturing a lithium-ion secondary battery, a negative electrode of a lithium-ion secondary battery, and a lithium-ion secondary battery of this embodiment are the same as those in the first embodiment.

According to this embodiment, a negative electrode of a lithium-ion secondary battery which satisfies (1) to (3) described above is realized. In addition, a lithium-ion secondary battery including a negative electrode of a lithium-ion secondary battery which satisfies (1) to (3) described above is realized. The present inventors confirm that the negative electrode of the lithium-ion secondary battery, and the lithium-ion secondary battery are excellent against an initial irreversible capacity and decomposition of an electrolytic solution.

### EXAMPLES

The method of the invention, in which the quality management method for the negative electrode of the lithium-ion secondary battery which has been described in the fourth embodiment was executed, was applied with respect to four kinds of carbon-based active materials A, B, C, and D in which an amorphous carbon coated layer was formed on a surface of secondary particles which were prepared from a nucleus material of natural graphite. A and D are different from B and C in a coating forming method. Specifically, A and D were prepared through pitch firing, and B and C were prepared through CVD. B and C are the same as each other in the nucleus material and the coating forming method, but are different from each other in a manufacturing lot. A and D are different from each other in a manufacturing maker, and thus may be different from each other in a gas composition of CVD. However, the comparison was performed with respect to arbitrary carbon-based active material, and examination was not made with respect to superiority or inferiority of the method of forming a coated layer.

The existence of a uniform amorphous carbon coating was not confirmed through observation with a transmission electron microscope, and thus it is considered that the average thickness of the coated layer is equal to or less than 10 nm in all of the active materials A to D.

First, with respect to each of the active materials A to D before heating, laser light having a beam diameter of approximately 0.4 μm was incident to active material particles at room temperature and in the air by using an argon ion laser having an excitation wavelength of 488 nm to measure a spectrum of scattered light in a Raman wavenumber shift range of 1000 cm⁻¹ to 1900 cm⁻¹. Each of the active materials is an aggregate of non-uniform particles, and a variation exists in a Raman scattering signal, and thus Raman scattering spectra of 16 active material particles were acquired for each sample. After a background was removed, the Raman scattering spectra were fitted with a sum of Lorentz functions with respect to the G peak (in the vicinity of 1580 cm⁻¹), the D peak (in the vicinity of 1360 cm⁻¹), and the D′ peak to assume parameters (an area, a position, and a width) of each peak, thereby calculating an average value of the 16 particles. The initial D/G ratio (peak area ratio) was approximately 0.65 in all of the active materials A to D, and was approximately the same in each case.

Next, TG-DTA was performed with respect to each of the active materials A to D in a mixed gas including 80% nitrogen and 20% oxygen under conditions in which a gas flow rate was set to 2.5 cm/s, a temperature scanning rate (a heating temperature rising rate) was set to 3 K/min, and an amount of a sample active material was set to 20 mg. It was confirmed that when a temperature was scanned up to 900° C., graphite of a nucleus material was combusted in all of the active materials A to D. It was considered that combustion of the amorphous carbon coated layer occurs at a temperature lower than the above-described temperature.

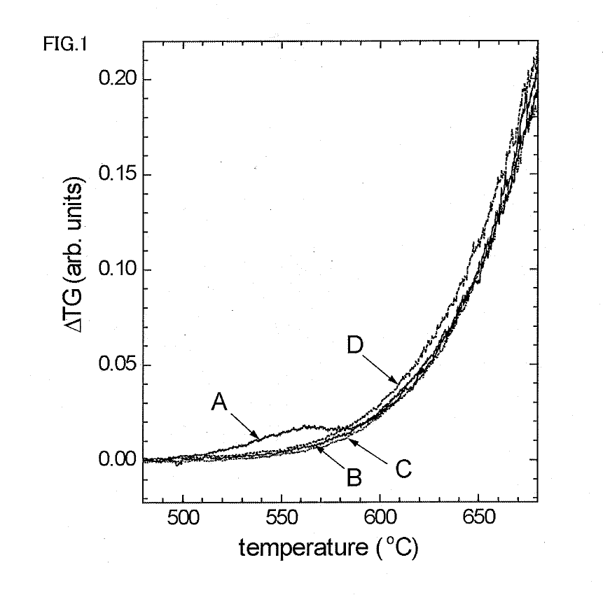

Measurement results of the weight loss (a temperature region equal to or lower than 680° C.) are illustrated in FIG. 1. The active material A exhibited a clear peak although the peak in the vicinity of 560° C. was low, and thus existence of the amorphous carbon coating was confirmed. However, the active materials B, C, and D have the same initial D/G ratio as that of the active material A, but did not exhibit a peak in a region equal to or lower than 680° C. in the TG-DTA. This indicates that quality management for the amorphous carbon coated layer of each of the active materials B, C, and D was difficult in Raman scattering measurement in the related art or the TG-DTA.

Next, the TG-DTA was performed with respect to each of the active materials A to D a plurality of times under the same conditions as described above while changing the upper limit temperature T [UL] of temperature scanning to 480° C., 600° C., 630° C., 655° C., and 680° C. At a stage in which the temperature reaches the upper limit temperature T [UL] during TG-DTA measurement, the heating was stopped, a composition of a supply gas was changed to 100% nitrogen, and combustion of a surface of each of the active materials was stopped. Then, a temperature was lowered to 50° C. or lower, remaining active material was collected from a furnace of the TG-DTA, and the Raman scattering measurement was performed with respect to the collected active material with the same method as described above.

FIG. 2 illustrates an aspect of plotting the D/G ratio (peak area ratio) with respect to the combustion temperature T (UL). The D/G ratio (initial D/G ratio) of the active materials which were not subjected to the TG-DTA is plotted with the combustion temperature T (UL) set to zero.

Here, in a case where the amorphous carbon film is homogeneous and/or uniform, the combustion temperature is spatially uniform, and thus combustion occurs at approximately the same temperature in any position on the surface of the active materials. As a result, attenuation in a D signal which is derived from the amorphous carbon occurs in a narrow temperature range. In contrast, in a case where the amorphous carbon film is not homogeneous and/or non-uniform, the combustion temperature is changed in accordance with a position on the surface of the active material, and thus a site in which the combustion temperature is high and a site in which the combustion temperature is low are distributed. As a result, a temperature range in which combustion occurs becomes broad, and thus the attenuation in the Raman D signal becomes gradual.

When referring to FIG. 2, the D/G ratio of the active material A is approximately the same as the initial value (initial D/G ratio) at a combustion temperature of 480° C., and this matches the fact that the weight loss is approximately zero (FIG. 1) in this temperature range. However, when the combustion temperature exceeds a low-temperature-side peak temperature (in the vicinity of 560° C.) of the weight loss and is raised up to 600° C., the D/G ratio greatly decreases. This indicates that the low-temperature-side peak in the weight loss is caused by combustion of the amorphous carbon. In addition, when raising the combustion temperature up to equal to or higher than 650° C. and equal to or lower than 700° C., although the weight loss rapidly increases, the D/G ratio is approximately constant. This represents that a component that is combusted at a high temperature of equal to or higher than 600° C. is only the graphite of the nucleus material.

Next, when considering the result of the active material B, a decrease in the D/G ratio occurs in accordance with the rising of the combustion temperature similar to the active material A, and existence of an unclear coated layer, which is unclear with only the TG-DTA, is detected. In addition, from FIG. 2, it was proven that a temperature range in which a decrease in the D/G ratio of the active material B occurs becomes broader (the D/G ratio gradually decreases) than that in the active material A. From the data, it is determined that the active material B has the amorphous carbon coated layer, but the coated layer of the active material B is less homogeneous and/or is less uniform in the film thickness in comparison to the coated layer of the active material A.

The active material C also exhibits approximately the same tendency as in the active material B, but a decrease in the D/G ratio occurs at a high temperature in comparison to the active material B. This represents that a variation in quality occurred between lots of B and C.

A decrease in the D/G ratio of the active material D was gradual in comparison to the active material A, but the decrease occurred on a low temperature side in comparison to the active materials B and C. From this result, it is determined that the coated layer of the active material D is less homogeneous and/or is less uniform in the film thickness in comparison to the coated layer of the active material A, but is more homogeneous and/or more uniform in the film thickness in comparison to the coated layers of the active materials B and C.

FIG. 3 illustrates an aspect of plotting the D/G ratio (peak area ratio) with respect to the weight loss. A decrease in the D/G ratio of the active material A occurs in a region in which the weight loss is relatively small. In contrast, a decrease in the D/G ratio of the active materials B, C, and D is more gradual in comparison to the active material A, and continues up to a relatively large weight loss. When comparing weight losses which correspond to a D/G ratio of 0.4, a relationship of A<D≈B<C is satisfied. Form this result, it can be seen that the coating of the active materials B, C, and D was non-uniform, an amount of coating thereof was greater than that of the active material A, and in the active materials B and C, the amount of coating was greater in the active material C and a variation occurred in the amount of coating between lots.

In description of inspection, quality management, and specifications of each active material, a plotting standard of FIG. 2 and/or FIG. 3 is set, and a deviation from the standard is monitored, or is designated. It is preferable that data points included in the standard are many. However, for a reduction in the number of analysis processes, a simple method of designating three points including two points on a low temperature side and a high temperature side in a transition region of the D/G ratio, and the initial D/G ratio during each plotting may be selected.

With regard to a lithium-ion secondary battery using a negative electrode in which carbon particles obtained by forming an amorphous carbon coated layer on secondary particles of a natural graphite nucleus material are set as an active material, conditions under which an initial irreversible capacity and decomposition of an electrolytic solution are compatible with each other were obtained by setting a data point to three points at an initial stage, 480° C., and 630° C. The present inventors confirmed the following situations. In a case where the initial D/G ratio (peak area ratio) was less than 0.5, occurrence of a gas due to decomposition of the electrolytic solution during charging and discharging cycles became significant. In addition, in a case where the initial D/G ratio (peak area ratio) was 0.65, and the D/G ratio (peak area ratio) at 480° C. was changed from the initial D/G ratio (peak area ratio) in a rate of change of greater than 10%, occurrence of a gas also increased. In addition, in a case where the D/G ratio (peak area ratio) at 630° C. exceeded 0.25, an increase in an initial irreversible capacity was observed. From these results, it is considered that an active material satisfying the following conditions is preferable. Specifically, the D/G ratio (peak area ratio) of the Raman scattering spectrum is equal to or greater than 0.5 (peak height ratio is equal to or greater than 0.25) at an initial stage, the D/G ratio does not decrease from the initial value by 10% or greater up to a combustion temperature of 480° C. in the TG-DTA, and the D/G ratio (peak area ratio) at a combustion temperature of 630° C. is equal to or less than 0.25 (peak height ratio is equal to or less than 0.12).

In the above-described example, the wavelength of the excitation light in the Raman scattering measurement was set to 488 nm. However, in the embodiment, if attention is given to a variation in the position and intensity of the D peak, visible laser light with another wavelength may be used. In addition, if attention is given to an effect of an oxygen concentration in a gas, a gas flow rate, an amount of a sample, and a temperature scanning rate, execution conditions of the TG-DTA may be appropriately changed.

As described above, according to this embodiment, during monitoring of a structure of the amorphous carbon coated layer formed on the graphite nucleus material secondary particles, comparison of a central value of the combustion temperature of the amorphous carbon coated layer, a width, and an amount of coating can be performed. When these parameters are added to inspection items, quality management is also possible even in a carbon-based negative electrode active material including a ultra-thin amorphous carbon coated layer having a thickness of equal to or less than 10 nm. When monitoring a transition in the parameters of an active material with which a reduction in the initial irreversible capacity and suppression of the decomposition of the electrolytic solution are compatible with each other, it is possible to stabilize mass production of a negative electrode using the active material, and a LIB cell using the negative electrode.

<Additional Attachments>

In addition, according to the above-described embodiments, the following inventions are disclosed.

<Invention 1>

A quality management method for a negative electrode active material of a lithium-ion secondary battery which includes an amorphous carbon layer on a surface,

wherein an aspect of a change in a plurality of D/G ratios, which are obtained by performing a first process of heating an inspection object at a predetermined heating temperature, and of measuring each of the D/G ratios through Raman scattering spectroscopy measurement a predetermined number of times while changing the heating temperature, is set as an index of the quality management.

<Invention 2>

The quality management method for a negative electrode active material of a lithium-ion secondary battery according to Invention 1,

wherein an aspect of a change in the D/G ratio with respect to a change in the heating temperature is set as the index of the quality management.

<Invention 3>

The quality management method for a negative electrode active material of a lithium-ion secondary battery according to Invention 2,

wherein a rate of change in the D/G ratio when the heating temperature is changed from a first temperature to a second temperature is set as an index of the quality management.

<Invention 4>

The quality management method for a negative electrode active material of a lithium-ion secondary battery according to any one of Invention 1 to Invention 3,

wherein in the first process, a reduction in weight of the inspection object which is caused by the heating is further measured, and an aspect of a change in the D/G ratio with respect to the reduction in weight of the inspection object is set as the index of the quality management.

<Invention 5>

The quality management method for a negative electrode active material of a lithium-ion secondary battery according to Invention 4,

wherein a rate of change in the D/G ratio when the reduction in weight is changed from a first state to a second state is set as the index of the quality management.

<Invention 6>

The quality management method for a negative electrode active material of a lithium-ion secondary battery according to any one of Invention 1 to Invention 5,

wherein in the first process, the inspection object is heated in an oxygen-containing atmosphere while raising a temperature thereof, and after reaching a predetermined temperature, the inspection object is subjected to Raman scattering spectroscopy measurement using visible laser light.

<Invention 7>

A method of manufacturing a negative electrode of a lithium-ion secondary battery, including:

a process of inspecting an inspection object by using the quality management method for a negative electrode active material of a lithium-ion secondary battery according to any one of Invention 1 to Invention 6.

<Invention 8>

A method of manufacturing a lithium-ion secondary battery, including:

a process of inspecting an inspection object by using the quality management method for a negative electrode active material of a lithium-ion secondary battery according to any one of Invention 1 to Invention 6.

<Invention 9>

A negative electrode active material of a lithium-ion secondary battery, including:

an amorphous carbon layer on a surface,

wherein a first D/G ratio (peak area ratio) before heating, which is obtained by Raman scattering spectroscopy measurement at an excitation wavelength of 488 nm at room temperature, is equal to or greater than 0.5,

the heating is performed while raising a temperature in a mixed gas atmosphere including 80% nitrogen and 20% oxygen under conditions in which a gas flow rate is set to 2.5 cm/s, a heating temperature rising rate is set to 3 K/min, and an amount of a sample is set to 20 mg,

when the heating temperature reaches 480° C., a second D/G ratio, which is obtained by the Raman scattering spectroscopy measurement at an excitation wavelength of 488 nm at room temperature, is changed from the first D/G ratio in a rate of change of less than 10%, and

when the heating temperature reaches 630° C., a third D/G ratio, which is obtained by the Raman scattering spectroscopy measurement at an excitation wavelength of 488 nm at room temperature, is equal to or less than 0.25.

<Invention 10>

A negative electrode that is manufactured by using the negative electrode active material according to Invention 9.

<Invention 11>

A lithium-ion secondary battery that is manufactured by using the negative electrode according to Invention 10.

Priority is claimed on Japanese Patent Application No. 2012-260850, filed Nov. 29, 2012, the content of which is incorporated herein by reference.

1. A quality management method for a negative electrode active material of a lithium-ion secondary battery which includes an amorphous carbon layer on a surface,
wherein an aspect of a change in a plurality of D/G ratios, which are obtained by performing a first process of heating an inspection object at a predetermined heating temperature, and of measuring each of the D/G ratios through Raman scattering spectroscopy measurement a predetermined number of times while changing the heating temperature, is set as an index of the quality management.

2. The quality management method for a negative electrode active material of a lithium-ion secondary battery according to claim 1,
wherein an aspect of a change in the D/G ratio with respect to a change in the heating temperature is set as the index of the quality management.

3. The quality management method for a negative electrode active material of a lithium-ion secondary battery according to claim 1,
wherein in the first process, a reduction in weight of the inspection object which is caused by the heating is further measured, and an aspect of a change in the D/G ratio with respect to the reduction in weight of the inspection object is set as the index of the quality management.

4. The quality management method for a negative electrode active material of a lithium-ion secondary battery according to claim 3,
wherein a rate of change in the D/G ratio when the reduction in weight is changed from a first state to a second state is set as the index of the quality management.

5. The quality management method for a negative electrode active material of a lithium-ion secondary battery according to claim 1,
wherein in the first process, the inspection object is heated in an oxygen-containing atmosphere while raising a temperature thereof, and after reaching a predetermined temperature, the inspection object is subjected to Raman scattering spectroscopy measurement using visible laser light.

6. A method of manufacturing a negative electrode of a lithium-ion secondary battery, comprising:
a process of inspecting an inspection object by using the quality management method for a negative electrode active material of a lithium-ion secondary battery according to claim 1.

7. A method of manufacturing a lithium-ion secondary battery, comprising:
a process of inspecting an inspection object by using the quality management method for a negative electrode active material of a lithium-ion secondary battery according to claim 1.

8. A negative electrode active material of a lithium-ion secondary battery, comprising:
an amorphous carbon layer on a surface,
wherein a first D/G ratio (peak area ratio) before heating, which is obtained by Raman scattering spectroscopy measurement at an excitation wavelength of 488 nm at room temperature, is equal to or greater than 0.5,
the heating is performed while raising a temperature in a mixed gas atmosphere including 80% nitrogen and 20% oxygen under conditions in which a gas flow rate is set to 2.5 cm/s, a heating temperature rising rate is set to 3 K/min, and an amount of a sample is set to 20 mg,
when the heating temperature reaches 480° C., a second D/G ratio, which is obtained by the Raman scattering spectroscopy measurement at an excitation wavelength of 488 nm at room temperature, is changed from the first D/G ratio in a rate of change of less than 10%, and
when the heating temperature reaches 630° C., a third D/G ratio, which is obtained by the Raman scattering spectroscopy measurement at an excitation wavelength of 488 nm at room temperature, is equal to or less than 0.25.

9. A negative electrode that is manufactured by using the negative electrode active material according to claim 8.

10. A lithium-ion secondary battery that is manufactured by using the negative electrode according to claim 9.
